(19) United States
(12) Patent Application Publication
(10) Pub. No.: US 2015/0352608 A1
(43) Pub. Date: Dec. 10, 2015

(54) SUBSTRATE TREATING APPARATUS AND METHOD FOR CLEANING THE SAME

(71) Applicant: SAMSUNG ELECTRONICS CO., LTD., Suwon-si (KR)

(72) Inventor: Tea-Geon KIM, Asan-si (KR)

(21) Appl. No.: 14/707,151

(22) Filed: May 8, 2015

(30) Foreign Application Priority Data
Jun. 10, 2014 (KR) 10-2014-0070255

(51) Int. Cl. B08B 9/46; B08B 9/08; B08B 5/02

(52) U.S. Cl. CPC B08B 9/46; B08B 5/02; B08B 9/08

(57) ABSTRACT

A substrate treating apparatus includes a chamber defining an inside space, a supply passage connected to the inside space to supply a cleaning gas for cleaning, a discharge passage connected to the inside space to discharge the cleaning gas from the inside space, and an exhaust member connected to the discharge passage for forcedly exhausting the cleaning gas from the inside space through the discharge passage.

### CROSS-REFERENCE TO RELATED APPLICATION

Korean Patent Application No. 10-2014-0070255, filed on Jun. 10, 2014, in the Korean Intellectual Property Office, and entitled: “Substrate Treating Apparatus and Method for Cleaning the Same,” is incorporated by reference herein in its entirety.

### BACKGROUND

1. Field

The present disclosure herein relates to a substrate treating apparatus and a method for cleaning the same.

2. Description of the Related Art

Particles may be generated in an inside space of a substrate treating apparatus. For example, reactants generated while treating a substrate in the inside space, foreign substances generated by friction between elements constituting the substrate treating apparatus, or the like may become particles.

### SUMMARY

The present disclosure provides a substrate treating apparatus and a method for cleaning the same capable of efficiently performing a cleaning.

Embodiments provide a substrate treating apparatus including a chamber defining an inside space, a supply passage connected to the inside space to supply a cleaning gas for cleaning, a discharge passage connected to the inside space to discharge the cleaning gas from the inside space, and an exhaust member connected to the discharge passage for forcedly exhausting the cleaning gas from the inside space through the discharge passage.

The supply passage may be inside the chamber.

The substrate treating apparatus may further include a blow member in the supply passage, the blow member forcing the cleaning gas toward the inside space of the chamber.

The substrate treating apparatus may further include a gas heating member in the supply passage, the gas heating member heating the cleaning gas.

The substrate treating apparatus may further include an ion supply unit fixed to the chamber, the ion supply unit supplying ions to the inside space.

The substrate treating apparatus may further include a particle sensor on an inside wall of the chamber, the particle sensor sensing particles in the inside space.

The substrate treating apparatus may further include a temperature sensor on an inside wall of the chamber, the temperature sensor sensing a temperature in the inside space.

Embodiments also provide a method for cleaning a substrate treating apparatus, including sensing an amount of particles in an inside space of a chamber, supplying a cleaning gas to the inside space of the chamber, and forcedly exhausting the cleaning gas from the inside space, when it is determined that the amount of the particles is not less than a cleaning start value, and ending the supplying and exhausting of the cleaning gas, when the sensed amount of particles in the inside space reaches a cleaning end value, or a predetermined time elapses after the supplying and exhausting are started.

When the amount of particles is not less than the cleaning start value, introduction of a new substrate into the chamber may be stopped, and a substrate already in the inside space may be treated and discharged.

The gas may be supplied to the inside space in a heated state.

A temperature of the cleaning gas may be raised when a temperature of the inside space is lower than a process temperature at which a process for a substrate is performed.

Ions may be supplied to the inside space during the supplying and exhausting of the cleaning gas.

The ions may be supplied to the inside space in a heated state.

A temperature of the ions may be raised when a temperature of the inside space is lower than a process temperature at which a process for a substrate is performed.

The cleaning start value may be set such that the amount of particles of the inside space is less by a buffer value than a failure occurrence value of the particles.

Embodiments also provide a substrate treating apparatus, including a chamber defining an inside space, a supply passage connected to the inside space to supply a cleaning gas for cleaning, a discharge passage connected to the inside space to discharge the cleaning gas from the inside space, an exhaust member connected to the discharge passage for forcedly exhausting the cleaning gas from the inside space through the discharge passage, and an ion supply unit through a sidewall of the chamber, the ion supply unit supplying ions to the inside space.

An end of the ion supply unit may include a nozzle inserted into the inside space.

The supply passage may be a channel inside the chamber, the supply passage being separated from the inside space by a filter.

The substrate treating apparatus may further include a heater and a blow member in the supply passage.

The substrate treating apparatus may further include a particle sensor inside the inside space to sense an amount of particles, the cleaning gas in the discharge passage further comprising particles from the inside space.

### BRIEF DESCRIPTION OF THE DRAWINGS

Features will become apparent to those of ordinary skill in the art by describing in detail exemplary embodiments with reference to the attached drawings, in which:

FIG. 1 illustrates a perspective view of a substrate treating system according to an embodiment;

FIG. 2 illustrates a cross-sectional view taken along line A-A of FIG. 1;

FIG. 3 illustrates a cross-sectional view taken along line B-B of FIG. 1;

FIG. 4 illustrates a schematic view of an ion supply unit from FIG. 3;

FIG. 5 illustrates a block diagram showing a control relationship of a substrate treating apparatus;

FIG. 6 illustrates a cross-sectional view of a substrate treating apparatus performing a cleaning operation;

FIG. 7 illustrates a flow chart of a method for performing a cleaning operation according to an embodiment;

FIG. 8 illustrates a graph showing a variation in the amount of particles in an inside space as time elapses;

FIG. 9 illustrates a cross-sectional view of a substrate treating apparatus according to another embodiment;

FIG. 10 illustrates a cross-sectional view of a substrate treating apparatus according to another embodiment; and

FIG. 11 illustrates a cross-sectional view of a substrate treating apparatus according to another embodiment.

### DETAILED DESCRIPTION OF THE EMBODIMENTS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

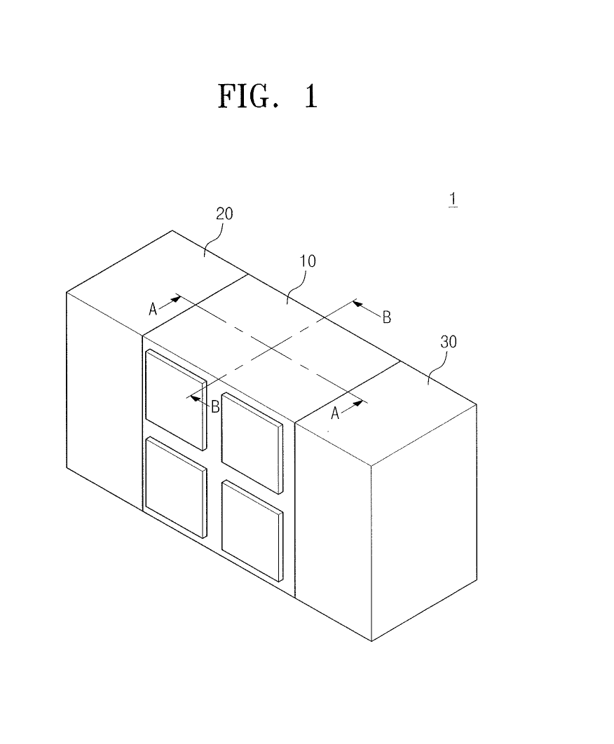

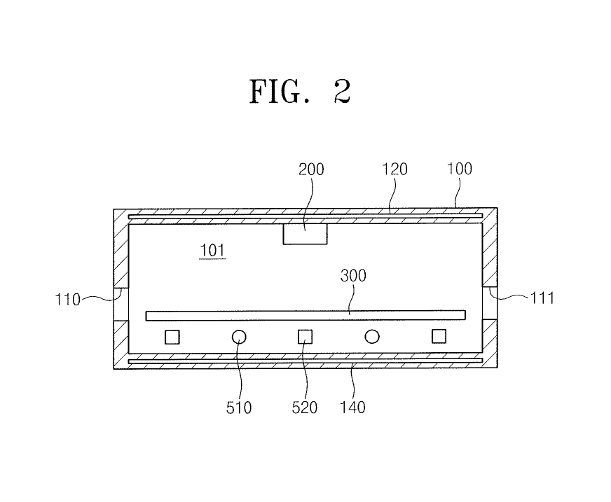

FIG. 1 is a perspective view of a substrate treating system according to an embodiment, and FIG. 2 is a cross-sectional view taken along line A-A of FIG. 1.

Referring to FIGS. 1 and 2, a substrate treating system 1 may include a substrate treating apparatus 10, a loading device 20, and an unloading device 30.

The substrate treating apparatus 10 treats a substrate. For example, the substrate may be a wafer on which a circuit is formed. In another example, the substrate may be a printed circuit board (PCB) or a lead frame.

The loading device 20 is disposed on a first side of the substrate treating apparatus 10 to load the substrate to be treated in the substrate treating apparatus 10. The unloading device 30 is disposed on a second side of the substrate treating apparatus 10 to unload the substrate to be treated from the substrate treating apparatus 10.

The substrate treating apparatus 10 may include a chamber 100, a substrate treating member 200, and a substrate support member 300.

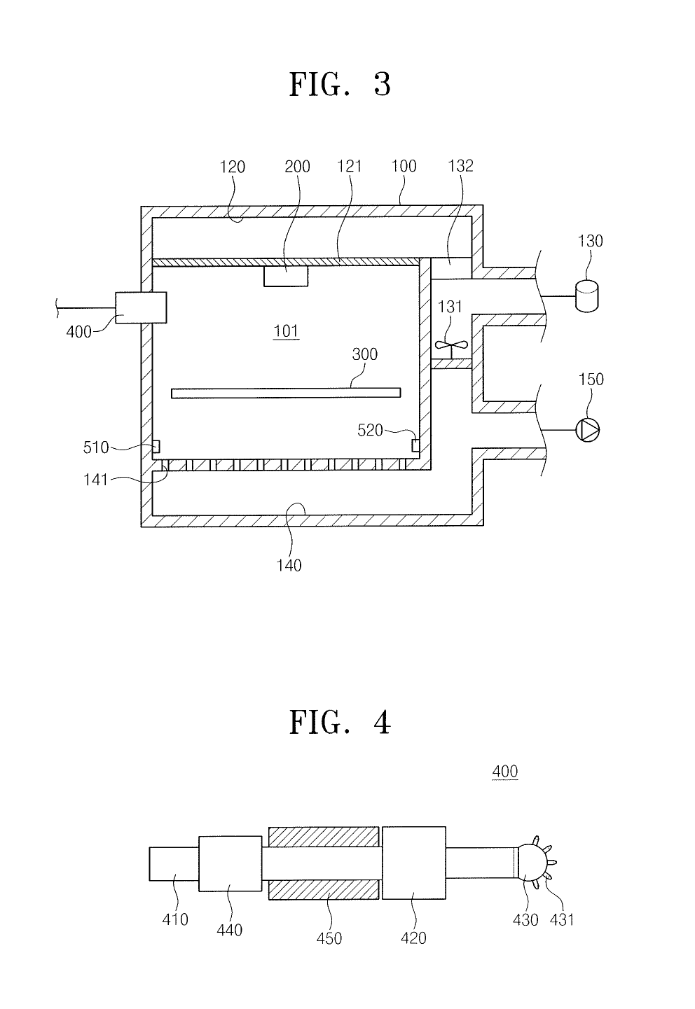

The chamber 100 includes walls defining an inside space 101 (FIG. 3) in which the substrate is treated. A first side. e.g., wall, of the chamber 100 may be formed with an inlet 110 through which the substrate to be treated is introduced. The inlet 110 may be formed in a direction in which the loading device 20 is disposed, i.e., the inlet 110 may be formed in the first side of the substrate treating apparatus 10 to face the loading device 20. Also, a second side of the chamber 100 may be formed with an outlet 111 through which the substrate to be treated is discharged. The outlet 111 may be formed in a direction in which the unloading device 30 is disposed, i.e., the outlet 111 may be formed in the second side of the substrate treating apparatus 10 to face the unloading device 30. The inlet 110 and the outlet 111 may be formed on both, i.e., opposite, sides of the chamber 100, respectively, so as to face each other.

The substrate treating member 200 is disposed inside the chamber 100, e.g., above the support member 300, to treat the substrate introduced into the chamber 100. In an example, the substrate treating member 200 may be a heater. The heater may be a type in which heat generated by electric resistance is used, a type in which heated air is sprayed, and a type in which light is irradiated. Also, the substrate treating apparatus 10 may perform a drying process for the substrate by using the heater. Further, the substrate treating apparatus 10 may perform a curing process for to the substrate to which a semiconductor chip is attached.

In another example, the substrate treating member 200 may be a process gas supply device. For example, the substrate treating apparatus 10 may perform a depositing process, an etching process, or an ashing process for the substrate by using a process gas provided by the substrate treating member 200. For example, the process gas supplied by the process gas supply device may be provided in a plasma state.

The substrate support member 300 supports the substrate to be treated inside the chamber 100. The substrate support member 300 may be provided such that a lower portion thereof is disposed on a lower surface of the chamber 100, or a side surface thereof is fixed to an inside surface of the chamber 100. In an example, the substrate support member 300 may be provided so as to transfer the substrate. For example. the substrate support member 300 may be provided as a conveyor belt or as rollers disposed in parallel to each other to move the substrate in one direction. Therefore, after the substrate is positioned on a portion of the substrate support member 300 adjacent to the inlet 110, the substrate may be treated while being transferred to a portion adjacent to the outlet 111. Also, the substrate support member 300 may support a plurality of substrates in such a manner that while a firstly introduced substrate is moved toward the outlet 111, a new substrate is positioned on the substrate support member 300.

FIG. 3 is a cross-sectional view of the substrate treating apparatus taken along line B-B of FIG. 1.

Referring to FIGS. 2 and 3, the inside space 101 of the chamber 100 is connected to a supply passage 120 and a discharge passage 140. For example, the supply passage 120 and discharge passage 140 may be channels leading into and out of the inside space 101, respectively. For example, the supply passage 120 and discharge passage 140 may be completely separate from each other.

The supply passage 120 may be formed inside the chamber 100. The supply passage 120 is connected to a cleaning gas supply source 130, e.g., the supply passage 120 may extend inside the chamber 100 from the cleaning gas supply source 130 to the inside space 101. The cleaning gas supply source 130 supplies a cleaning gas used in cleaning the chamber 100, e.g., the cleaning gas may be a nitrogen gas. The supply passage 120 may be provided so as to be connected to an upper portion of the inside space 101, e.g., the supply passage 120 may be formed so as to be connected to the inside space 101 in an inside upper surface of the chamber 100. A filter 121 may be disposed in a portion in which the supply passage 120 and the inside space 101 are connected to each other, so gas from the supply passage 120 passes into the inside space 101 through the filter 121. The filter 121 removes foreign substances included in cleaning gas introduced into the inside space 101 from the supply passage 120.

A blow member 131 may be provided on a path through which the cleaning gas is supplied. In an example, the blow member 131 may be in the supply passage 120 formed inside the chamber 100. For example, as illustrated in FIG. 3, the blow member 131 may be in a portion of the supply passage 120 adjacent to the cleaning gas supply source 130, e.g., the blow member 131 may be in a portion of the supply passage 120 below an intersection of the supply passage 120 with the cleaning gas supply source 130, to blow the cleaning gas from the cleaning gas supply source 130 up into the supply passage 120. The blow member 131 applies pressure into the supply passage 120, and thus allows the cleaning gas supplied from the cleaning gas supply source 130 to the supply passage 120 to flow into the inside space 101.

A gas heating member 132 may be provided on the path through which the cleaning gas is supplied, e.g., in a portion of the supply passage 120 above the intersection of the supply passage 120 with the cleaning gas supply source 130. The gas heating member 132 heats the cleaning gas supplied to the inside space 101 from the cleaning gas supply source 130.

The discharge passage 140 may be formed inside the chamber 100. The discharge passage 140 discharges gas from the inside space 101. The discharge passage 140 may be provided so as to be connected to a lower portion of the inside space 101. In an example, the discharge passage 140 may be formed so as to be connected to discharge holes 141 formed on a lower surface of the inside of the chamber 100, e.g., the discharge passage 140 may be in fluid communication with the inside space 101 of the chamber 100 through the discharge holes 141. The discharge passage 140 may be connected to an exhaust member 150. The exhaust member 150 may apply an inhaling pressure to the discharge passage 140 to forcedly exhaust gas from the inside space 101 through the discharge passage 140, e.g., the exhaust member 150 may exhaust gas from the inside space 101 through the discharge passage 140 and the discharge holes.

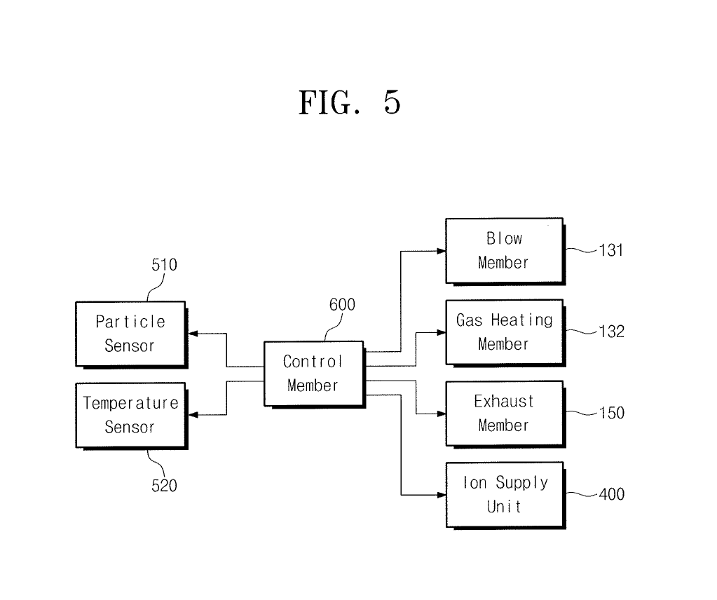

As further illustrated in FIG. 3, the substrate treating apparatus 10 may be provided with an ion supply unit 400 supplying ions to the inside space 101. The ion supply unit 400 may be fixed to the chamber 100, such that one end thereof is connected to the inside space 101. The ion supply unit 400 will be described in more detail with reference to FIG. 4.

FIG. 4 is a schematic view of the ion supply unit 400. As illustrated in FIG. 4, the ion supply unit 400 may include a body 410, an ionizer 420, and a spray member 430.

The body 410 constitutes a frame of the ion supply unit 400. A first side of the body 410 is connected to the gas supply source 130, while a second side of the body 410 is in the inside space 101. The body 410 is formed with a passage. i.e., channel, therethrough, so gas supplied from the gas supply source 130 to the first side of the body 410 flows through the passage.

The ionizer 420 is disposed on the passage through which the gas flows. The ionizer 420 ionizes the gas flowing therethrough. In other words, gas supplied from the gas supply source 130 to the first side of the body 410 flows through the passage in the body 410, and is ionized by the ionizer 420.

The spray member 430 is disposed at the second side the body 410 that is in the inside space 101. When the ion supply unit 400 is fixed to the chamber 100, the spray member 430 is disposed in the inside space 101. The spray member 430 sprays the gas flowing through the body 410 into the inside space 101. The spray member 430 may be rotatably provided with respect to the body 410. Therefore, the gas may be sprayed from the spray member 430 so as to be widely spread into the inside space 101.

The spray member 430 is provided with a nozzle 431. At least one nozzle 431 may be provided in the spray member 430. When the spray member 430 is provided with a plurality of nozzles 431, the plurality of nozzles 431 are disposed in different directions, respectively. Therefore, the gas sprayed from the plurality of nozzles 431 may be widely spread into the space 101.

The body 410 may be further provided with a filter 440 disposed on the path through which the gas flows. The filter 440 removes foreign substances included in the gas flowing through the passage formed in the body 410. For example, the filter 440 may be positioned at an opposite side to the spray member 430 with respect to the ionizer 420. That is, as illustrated in FIG. 4, the ionizer 420 may be between the filter 440 and the spray member 430, so filtered gas is ionized in the ionizer 420 before being sprayed through the spray member 430 into the inside space 101. In another example, the filter 440 may be disposed between the ionizer 420 and the spray member 430.

The body 410 may be further provided with a heater 450 on the path through which the gas flows. The heater 450 heats the gas flowing through the passage formed in the body 410. For example, the heater 450 may be positioned at an opposite side to the spray member 430 with respect to the ionizer 420, i.e., the ionizer 420 may be between the heater 450 and the spray member 430 (FIG. 4). In another example, the heater 450 may be disposed between the ionizer 420 and the spray member 430.

Referring back to FIGS. 2-3, the substrate treating apparatus 10 may be provided with a particle sensor 510. For example, at least one particle sensor 510 may be disposed in the inside space 101 to sense an amount of particles in the inside space 101. The particle sensor 510 may be disposed in an inside wall or in a lower wall of the chamber 100 so as to be disposed in a lower portion of the inside space 101, e.g., the particle sensor 510 may be on an inner wall of the inner space 101 and adjacent to the discharge holes 141 (FIG. 3) or between the support 300 and a bottom of the chamber 100 (FIG. 2).

In a case of particles floating in the inside space 101, the amount of particles may be different according to a position of the inside space 101. In detail, an amount of particles existing in a lower portion of the inside surface 101 is greater than that of particles existing in an upper portion of the inside space 101 due to the weight of particles. Therefore, the particle sensor 510 may be provided as a single device or multiple devices on the inside wall or the lower wall of the chamber 100 to efficiently sense the amount of the particles of the inside space 101.

In another example, the particle sensor 510 may be disposed in the discharge passage 140 to sense the amount of particles included in the gas discharged to the discharge passage 140.

The substrate treating apparatus 10 may further be provided with at least one temperature sensor 520. The temperature sensor 520 may be disposed on an inside wall of the chamber 100 to sense temperature of the inside space 101. When the temperature sensor 520 is provided in plurality, the plurality of temperature sensors 520 may be provided on an upper wall, a lower wall, and a side wall of the chamber 100, respectively, so as to be disposed in an upper portion and a lower portion of the inside space 101, respectively. Further, the temperature sensors 520 may be provided on only a portion of the upper wall, the lower wall, and the side wall of the chamber 100.

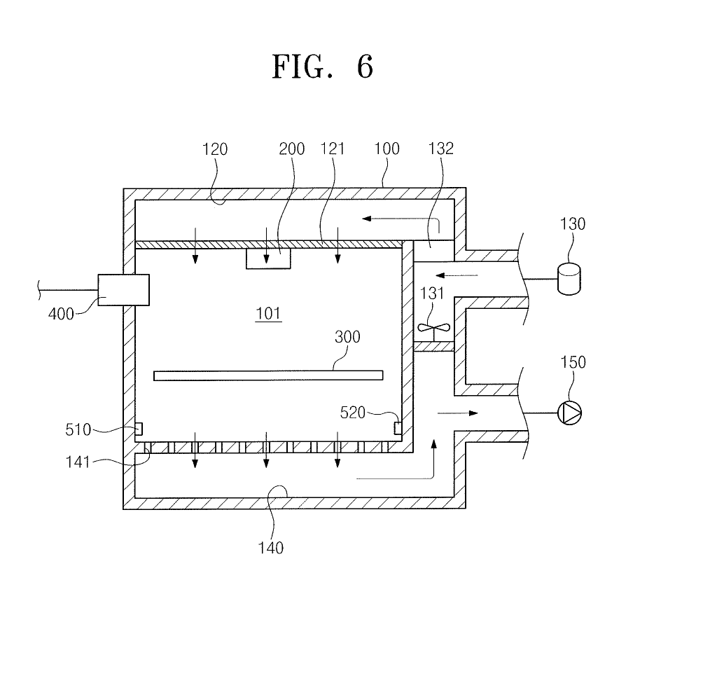

FIG. 5 is a block diagram showing a control relationship of the substrate treating apparatus 10. FIG. 6 is a cross-sectional view of the substrate treating apparatus 10 performing a cleaning operation.

Referring to FIGS. 5 and 6, the substrate treating apparatus 10 automatically performs a cleaning operation using a signal supplied from the particle sensor 510. That is, the particle sensor 510 transmits information regarding the amount of particles in the inside space 101 to a control member 600, and the control member 600 starts a cleaning operation for the substrate treating apparatus 10 using the received signal when the amount of particles is not less than a predetermined value, e.g., not less than a cleaning start value.

In detail, the control member 600 operates the blow member 131 to supply the cleaning gas to the inside space 101 through the supply passage 120. Also, the control member 600 operates the exhaust member 150 to forcedly exhaust the cleaning gas with the particles from the inside space 101 through the gas discharge passage 140. For example, the control member 600 may operate the blow member 131 and the exhaust member 150 at the same time. In another example, the control member 600 may firstly operate only one of the blow member 131 and the exhaust member 150. As a result, the particles in the inside space 101 are discharged to the outside through the discharge passage 140 by supplying and exhausting the cleaning gas.

When the supply passage 120 is connected to the upper portion of the inside space 101 and the discharge passage 140 is connected to the lower portion of the inside space 101, a flow of the cleaning gas is formed from the upper portion to the lower portion of the inside space 101 (see arrows pointing from the filter 121 toward the discharge holes 141). Therefore, particles floating in the lower portion of the inside space 101 or particles accumulated on the lower wall of the chamber 100 may be smoothly discharged to the discharge passage 140 through the discharge holes 141 with the exhausted cleaning gas.

When a cleaning operation is started, the control member 600 may operate the ion supply unit 400 to supply ions to the inside space 101. For example, while the cleaning is performed, the control member 600 may continuously operate the ion supply unit 400 to continuously supply ions together with the cleaning gas, i.e., the ion supply unit 400 and the blow member 131 (through the supply passage 120) provide the respective ions and cleaning gas continuously and simultaneously into the inside space 101. In another example, while the cleaning operation is performed, the control member 600 may operate the ion supply unit 400 such that ions are supplied only during a predetermined time, i.e., operation of the ion supply unit 400 may be periodic, e.g., intermittent, and overlap only a portion of the operation of the blow member 131 blowing the cleaning gas into the inside space 101 through the supply passage 120.

Particles in the inside space 101 may be charged. Charges of particles generate a force of attraction between the particles and the chamber 100, thereby obstructing, e.g., preventing, the flow of particles from the inside space 101 to the discharge passage 140. However, the ions provided by the ion supply unit 400 may react with the charged particles to neutralize the particles. Therefore, when ions are supplied in accordance with embodiments, the force of attraction between the particles and the chamber 100 is removed, thereby facilitating a smooth flow of the particles from the inside space 101 to the discharge passage 140.

The control member 600 may operate the gas heating member 132 in accordance with the temperature sensor 152 to supply heated cleaning gas to the inside space 101 when needed. In detail, when a temperature of the cleaning gas and a temperature of the chamber 100 are different from each other, a heat exchange is generated between the cleaning gas and the chamber 100. For example. when the temperature of the cleaning gas is lower than that of the chamber 100, the chamber 100 is cooled. As such, the heated cleaning gas may prevent or substantially minimize cooling of the chamber 100 in order to maintain a constant temperature in the chamber 100, i.e., a process performed in the substrate treating apparatus 10 may be performed at a constant temperature.

In an example, when a process performed by the substrate treating apparatus 10 is a drying process or a curing process, a treatment for the substrate is performed in the inside space 101 at a predetermined, e.g., heated, process temperature. However, if the inside space 101 were to be cooled during the cleaning operation to a temperature lower than a required process temperature, a subsequent treatment for the substrate would be delayed until the required process temperature is reached.

In contrast, according to embodiments, the substrate treating apparatus 10 provides heated cleaning gas into the inside space 101, thereby preventing cooling of the inside space 101 in the cleaning operation. Therefore, after the cleaning process is performed, a subsequent treatment of the substrate may be started (or re-started) directly and without delay. Also, when the cleaning gas is supplied in a heated state, an efficiency for removing particles attached to the chamber 10 may be increased.

The control member 600 may reflect data transmitted by the temperature sensor 520 on the heating level of the cleaning gas. In detail, when it is sensed that the inside space 101 is cooled, the control member 600 may control the gas heating member 132 such that the heating level of the cleaning gas is increased. Also, when it is determined that the temperature of the inside space 101 exceeds the process temperature, the control member 600 may control the gas heating member 132 to reduce the heating level of the cleaning gas, or stop operation of the gas heating member 132.

Further, the control member 600 may operate the heater 450 of the ion supply unit 400 to supply heated ions to the inside space 101. Therefore, the inside space 101 may be prevented from being cooled, and an efficiency for removing the particles may be improved. Since the method in which the control member 600 controls the heater 450 using data transmitted by the temperature sensor 520 is similar to a method in which the control member 600 controls the gas heating member 132, repeated descriptions will be omitted.

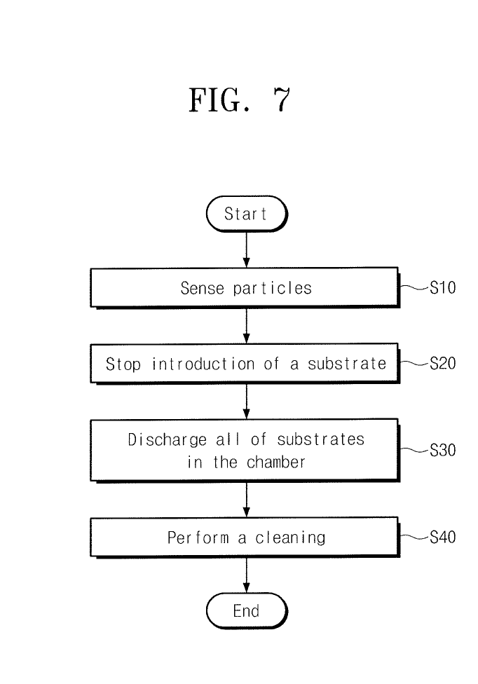

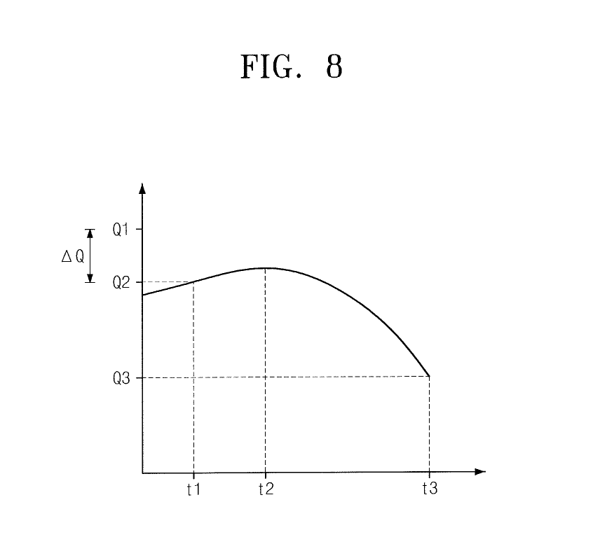

FIG. 7 is a flow chart showing a method for performing a cleaning operation according to an embodiment. FIG. 8 is a graph showing a variation in the amount of particles in the inside space 101 as time elapses. Hereinafter, a method for cleaning with the substrate treating apparatus 10 will be described with reference to FIGS. 5-8.

Referring to FIGS. 5-8, the control member 600 senses an amount of particles in the inside space 101 through data transmitted by the particle sensor 510 (S10). The control member 600 senses the amount of particles in the inside space 101 in consideration of a failure occurrence value Q1 and a cleaning start value Q2. The failure occurrence value Q1 is set in consideration of a failure occurrence proportion of the treated substrates. That is, the failure occurrence value Q1 is set in consideration of the amount of particles with which a failure of the treated substrates is significantly increased. The cleaning start value Q2 is defined as a value obtained by subtracting a buffer value ΔQ from the failure occurrence value Q1.

When the amount of particles in the inside space 101 is the cleaning start value Q2 or higher in accordance with the data transmitted by the particle sensor 510 (time t1), introduction of the substrate to the inside space 101 is stopped (S20). In detail, when it is determined that the amount of particles of the inside space 101 is the cleaning start value Q2 or higher, any substrate already in the inside space 101 may be treated in a state that the substrate is disposed in the inside space 101. For example, while at least one substrate is supported on the substrate support member 300 in the inside space 101 and is moved toward the outlet 111, the drying process or the curing process may be performed. Since the cleaning start value Q2 is set in consideration of the buffer value ΔQ, the substrate disposed in the inside space 101, after introduction of the substrate to the inside space 101 is stopped, may be treated in a low failure proportion.

Next, when all of the substrates already in the inside space 101 are treated, all of the substrates are discharged from the chamber 100 (S30). Then, in time t2, a cleaning operation for the inside space 101 is started (S40). For example, the cleaning operation may be continuously performed during a preset time, e.g., regardless of the amount of particles. In another example, the cleaning may be performed until the amount of particles sensed through the data transmitted by the particle sensor 510 reaches a cleaning end value Q3, i.e., at time t3. Since the temperature of the inside space 101 is also maintained at the process temperature during the cleaning operation, after cleaning, a new substrate is directly introduce to the inside space 101 without delay so as to perform a process.

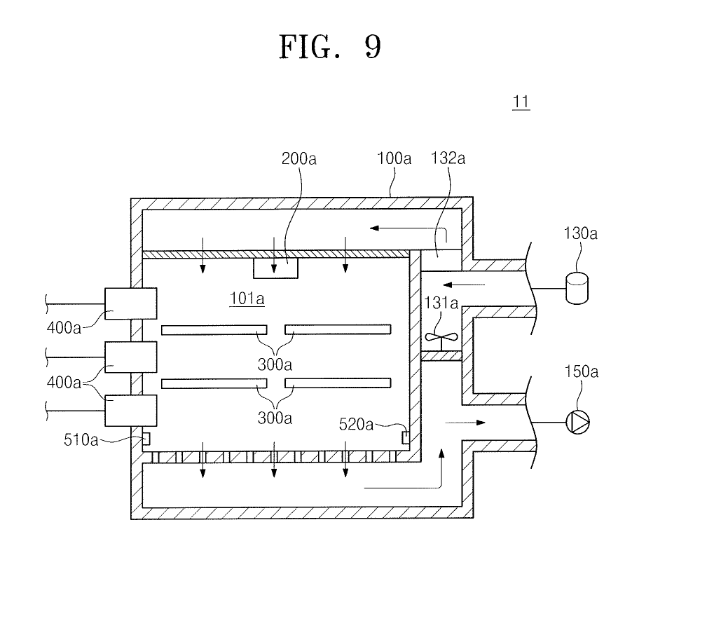

FIG. 9 is a cross-sectional view illustrating a substrate treating system according to another embodiment.

Referring to FIG. 9, a substrate treating apparatus 11 may include a chamber 100a, a cleaning gas supply source 130a, an exhaust member 150a, a substrate treating member 200a, a substrate support members 300a, a blow member 131a, a gas heating member 132a, ion supply units 400a, a particle sensor 510a, and a temperature sensor 520a.

The chamber 100a, the cleaning gas supply source 130a, the exhaust member 150a, the substrate treating member 200a, the blow member 131a, the gas heating member 132a, the particle sensor 510a, and the temperature sensor 520a of the substrate treating apparatus 11 may be provided equally or similarly to the chamber 100, the cleaning gas supply source 130, the exhaust member 150, the substrate treating member 200, the blow member 131, the gas heating member 132, the particle sensor 510, and the temperature sensor 520, respectively, of the substrate treating apparatus 10 in FIG. 3.

The substrate treating apparatus 11 may be provided with the plurality of substrate support members 300a. For example, the plurality of substrate support members 300a may be spaced apart from each other horizontally and/or vertically, i.e., upward and downward and/or left and right. Therefore, the number of substrates treated at the same time may be increased. Each of the substrate support members 300a may be provided equally or similarly to the substrate support member 300 of the substrate treating apparatus 10 of FIGS. 2 and 3.

The substrate treating apparatus 11 may be provided with the plurality of ion supply units 400a. For example, the plurality of ion supply units 400a may be disposed on a portion of a side wall, an upper wall, and/or a lower wall of the chamber 100a. For example, as illustrated in FIG. 9, the plurality of ion supply units 400a may be spaced apart from each other vertically along a same wall. Each of the plurality of ion supply unit 400a supplies ions to the inside space 101a, and thus the ions may be uniformly supplied to the inside space 101a. Therefore, charged particles may be efficiently neutralized. Each of the ion supply units 400a may be provided equally or similarly to the ion supply unit 400 of FIG. 1.

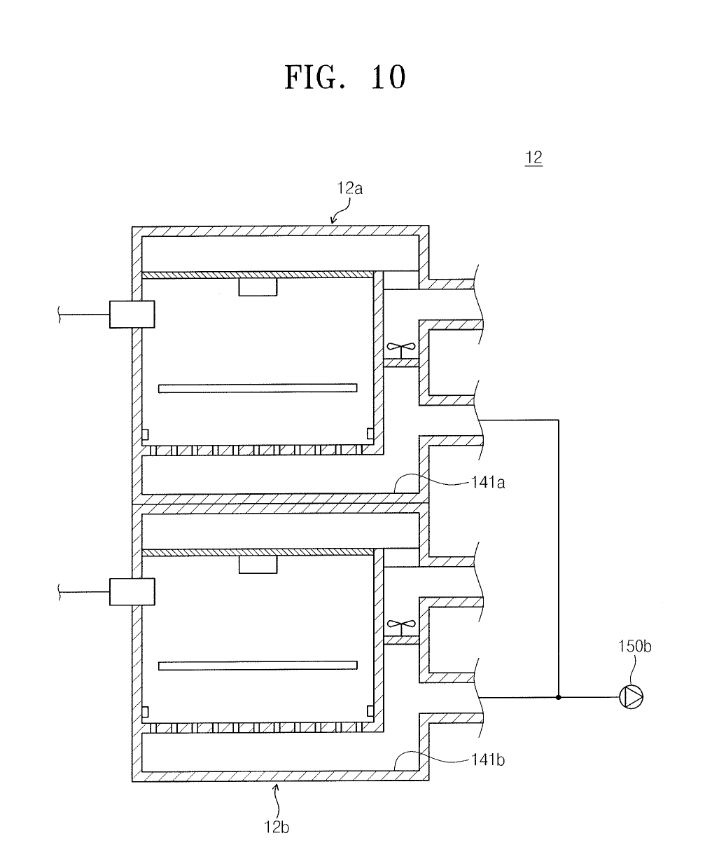

FIG. 10 is a cross-sectional view illustrating a substrate treating system according to another embodiment.

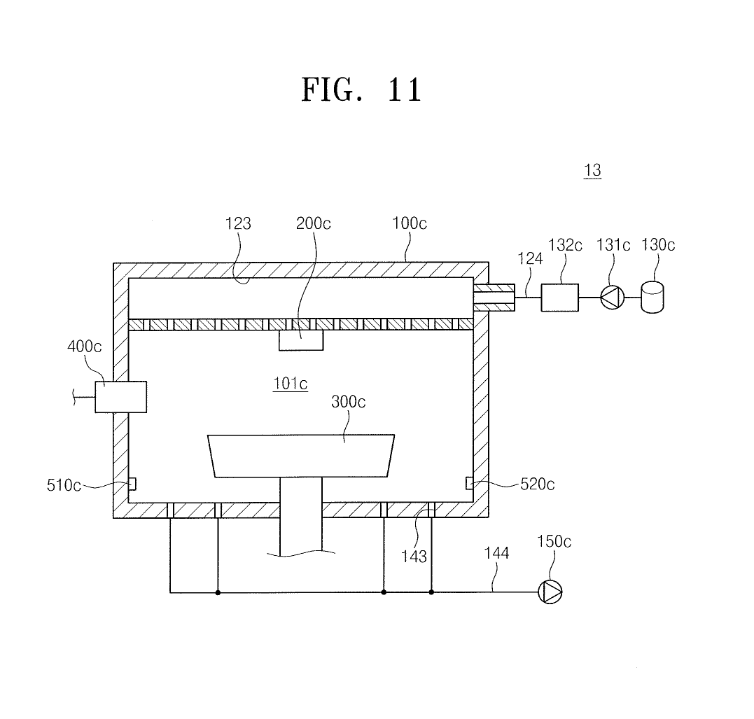

Referring to FIG. 10, a substrate treating apparatus 12 may include a first chamber 12a and a second chamber 12b. The first chamber 12a and the second chamber 12b may be spaced apart from each other horizontally or vertically, i.e., upward and downward or left and right, respectively. Each of the first chamber 12a and the second chamber 12b may be provided equally or similarly to the substrate treating apparatus 10 of FIG. 3 or the substrate treating apparatus 11 of FIG. 11. A discharge passage 141a of the first chamber 12a and a discharge passage 141b of the second chamber 12b may be connected to one exhaust member 150, and thus be provided so as to forcedly exhaust a gas of the inside space 101.

FIG. 11 is a cross-sectional view illustrating a substrate treating apparatus according to another embodiment.

Referring to FIG. 11, a substrate treating apparatus 13 may include a chamber 100c, a cleaning gas supply source 130c, an exhaust member 150c, a substrate treating member 200c, a substrate support member 300c, a blow member 131c, a gas heating member 132c, an ion supply unit 400c, a particle sensor 510c, and a temperature sensor 520c.

The substrate treating member 200c, the ion supply unit 400c, the particle sensor 510c, and the temperature sensor 520c may be provided equally or similarly to the substrate treating member 200, the ion supply unit 400, the particle sensor 510, and temperature sensor 520 of the substrate treating apparatus 10 of FIGS. 2 and 3.

A supply passage 123 may be formed in the chamber 100c. The supply passage 123 may be formed so as to be connected an upper portion of the inside space 101c. The supply passage 123 is connected to a cleaning gas supply source 130c through a supply pipe 124. The supply pipe 124 may be provided with a blow member 131c applying a pressure that allows a cleaning gas to flow to the inside space 101c, and a heating member 132c heating the cleaning gas. The substrate support member 300c is disposed in the inside space 101c to support the substrate to be treated.

At least one discharge hole 143 for discharging a gas of the inside space 101c may be formed in the chamber 101c. The discharge hole 143 may be formed so as to be connected to a lower portion of the inside space 101. For example, the discharge hole 143 may be formed on a lower wall or a lower portion of a side wall of the chamber 100c. Also, each of the discharge holes 143 may be connected to a discharge pipe 144. The discharge pipe 144 may be provided with an exhaust member 150c to apply a pressure for forcedly exhaust the gas of the inside space 101c.

By way of summation and review, when an amount of particles in a process chamber is increased, the failure rate of the substrate treated in the process chamber is increased. Such a substrate failure rate may be rapidly increased when the amount of particles exceeds a predetermined amount. Therefore, a substrate treating apparatus is frequently required to undergo a cleaning operation to reduce the amount of particles therein. Therefore, according to an embodiment, a cleaning operation of a substrate treating apparatus may be efficiently performed.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A substrate treating apparatus, comprising:
a chamber defining an inside space;
a supply passage connected to the inside space to supply a cleaning gas for cleaning;
a discharge passage connected to the inside space to discharge the cleaning gas from the inside space; and
an exhaust member connected to the discharge passage for forcedly exhausting the cleaning gas from the inside space through the discharge passage.

2. The substrate treating apparatus as claimed in claim 1, wherein the supply passage is inside the chamber.

3. The substrate treating apparatus as claimed in claim 1, further comprising a blow member in the supply passage, the blow member forcing the cleaning gas toward the inside space of the chamber.

4. The substrate treating apparatus as claimed in claim 1, further comprising a gas heating member in the supply passage, the gas heating member heating the cleaning gas.

5. The substrate treating apparatus as claimed in claim 1, further comprising an ion supply unit fixed to the chamber, the ion supply unit supplying ions to the inside space.

6. The substrate treating apparatus as claimed in claim 1, further comprising a particle sensor on an inside wall of the chamber, the particle sensor sensing particles in the inside space.

7. The substrate treating apparatus as claimed in claim 1, further comprising a temperature sensor on an inside wall of the chamber, the temperature sensor sensing a temperature in the inside space.

8. A method for cleaning a substrate treating apparatus, the method comprising:
sensing an amount of particles in an inside space of a chamber;
supplying a cleaning gas to the inside space of the chamber, and forcedly exhausting the cleaning gas from the inside space, when it is determined that the amount of the particles is not less than a cleaning start value; and
ending the supplying and exhausting of the cleaning gas, when the sensed amount of particles in the inside space reaches a cleaning end value, or a predetermined time elapses after the supplying and exhausting are started.

9. The method as claimed in claim 8, wherein, when the amount of particles is not less than the cleaning start value, introduction of a new substrate into the chamber is stopped, and a substrate already in the inside space is treated and discharged.

10. The method as claimed in claim 8, wherein the cleaning gas is supplied to the inside space in a heated state.

11. The method as claimed in claim 10, wherein a temperature of the cleaning gas is raised when a temperature of the inside space is lower than a process temperature at which a process for a substrate is performed.

12. The method as claimed in claim 8, wherein ions are supplied to the inside space during the supplying and exhausting of the cleaning gas.

13. The method as claimed in claim 12, wherein the ions are supplied to the inside space in a heated state.

14. The method as claimed in claim 13, wherein a temperature of the ions is raised when a temperature of the inside space is lower than a process temperature at which a process for a substrate is performed.

15. The method as claimed in claim 8, wherein the cleaning start value is set such that the amount of particles of the inside space is less by a buffer value than a failure occurrence value of the particles.

16. A substrate treating apparatus, comprising:
a chamber defining an inside space;
a supply passage connected to the inside space to supply a cleaning gas for cleaning;
a discharge passage connected to the inside space to discharge the cleaning gas from the inside space;
an exhaust member connected to the discharge passage for forcedly exhausting the cleaning gas from the inside space through the discharge passage; and
an ion supply unit through a sidewall of the chamber, the ion supply unit supplying ions to the inside space.

17. The substrate treating apparatus as claimed in claim 16, wherein an end of the ion supply unit includes a nozzle inserted into the inside space.

18. The substrate treating apparatus as claimed in claim 16, wherein the supply passage is a channel inside the chamber, the supply passage being separated from the inside space by a filter.

19. The substrate treating apparatus as claimed in claim 18, further comprising a heater and a blow member in the supply passage.

20. The substrate treating apparatus as claimed in claim 16, further comprising a particle sensor inside the inside space to sense an amount of particles, the cleaning gas in the discharge passage further comprising particles from the inside space.
